(19) United States
(12) Patent Application Publication
(10) Pub. No.: US 2026/0238128 A1
(43) Pub. Date: Aug. 13, 2026

(54) DC-DC BOOST CONVERTER CIRCUIT DEVICE

(71) Applicant: KOREA UNIVERSITY RESEARCH AND BUSINESS FOUNDATION, Seoul (KR)

(72) Inventors: Hyung-Min LEE, Seoul (KR); Min Su KIM, Seoul (KR)

(21) Appl. No.: 19/450,562

(22) Filed: Jan. 15, 2026

(30) Foreign Application Priority Data
Feb. 13, 2025 (KR) 10-2025-0018437

(51) Int. Cl. H02M 3/158

(52) U.S. Cl. CPC H02M 3/158

(57) ABSTRACT

A DC-DC boost converter circuit apparatus is disclosed. The DC-DC boost converter circuit apparatus includes: an inductor (L); a first flying capacitor (C_{X}) having a first terminal connected to a first terminal of the inductor (L) via a junction node (V_{X1}); a second flying capacitor (C_{Y}) having a first terminal connected to a second terminal of the inductor (L) via a junction node (V_{Y1}); and first to sixth switches (S₁ to S₆) configured to be selectively switched, depending on an operating mode, to deliver current to an output capacitor (C_{OUT}) through either (i) a single path through the inductor (L) or (ii) a dual path through the inductor (L) and the second flying capacitor (C_{Y}).

### CROSS-REFERENCE TO RELATED APPLICATION

This application claims the benefit of priority under 35 U.S.C. § 119 (a) to Korean Patent Application No. 10-2025-0018437, filed on Feb. 13, 2025, the entire contents of which is incorporated herein by reference.

### BACKGROUND

### (a) Technical Field

The present disclosure relates to a DC-DC boost converter circuit apparatus with improved power efficiency and frequency response.

### (b) Background Art

A boost converter is a circuit technology that supplies a DC voltage higher than an input DC voltage to internal systems required in mobile devices powered by a lithium-ion battery or USB, such as an OLED driver and battery charging. Early boost converters had a simple structure including two switches and one inductor; however, to optimize performance to meet specification requirements demanded by various applications, hybrid boost converters that additionally employ inductors, capacitors, and switches have been studied.

It is desirable to ensure that switches formed by transistors within the converter are subjected to low voltage stress. High-voltage transistors (e.g., LDMOS) fabricated to withstand high voltage stress exhibit larger parasitic capacitances for the same on-resistance than low-voltage transistors (e.g., CMOS), and require additional process cost. Accordingly, to reduce switching loss, achieve high efficiency, and lower manufacturing cost, the internal switches of the converter should be implemented using low-voltage transistors.

To implement a high-efficiency boost converter, the current flowing through the inductor should be minimized. The inductor includes a parasitic resistance component, i.e., a parasitic DC resistance (DCR), which generally has a trade-off relationship with the inductor volume. In mobile devices with spatial constraints, it is difficult to use a large inductor, and the resulting DCR can be several times larger than the switch on-resistance. Accordingly, to reduce conduction loss in the inductor DCR and achieve high efficiency, the inductor current should be minimized.

To improve the frequency response of the converter, a right-half-plane (RHP) zero should be eliminated. Control of the converter is implemented as a negative-feedback loop that senses an output error and drives the error to zero (i.e., causes the output to converge to a target value). To ensure stability of the negative-feedback loop, the phase margin—indicating how much phase headroom exists from −180° at the frequency where the loop gain is 0 dB—should be maintained above a predetermined level. However, an RHP zero increases the loop gain while decreasing the phase, thereby reducing the phase margin and degrading stability. Due to these characteristics of the RHP zero, increasing the feedback-loop bandwidth to higher frequencies is limited. Accordingly, to improve the converter frequency response, it is necessary to mitigate or eliminate the effect of the RHP zero.

FIG. 1(a) illustrates a conventional boost converter having the simplest configuration, and FIG. 1(b) illustrates a converter that employs an inductor-capacitor dual-path (LC dual-path) technique in which one additional capacitor is provided so that the output current is delivered through not only the inductor but also the capacitor, thereby reducing the inductor current. Further, FIG. 1(c) illustrates a converter that uses two inductors to reduce the current flowing through each inductor and to supply a continuous current to the output.

For the conventional converters, the maximum voltage stress is VOUT, 2VOUT−VIN, and VOUT for (a), (b), and (c), respectively, and the sum of the inductor currents is 1/(1−D), 1/(2−2D), and 1/(1−D) times the load current, respectively. Here, VIN denotes an input voltage and VOUT denotes an output voltage. In addition, D is a duty ratio of a PWM (pulse width modulation) signal and has a value between 0 and 1. With respect to voltage stress, since the required process may change depending on the maximum value within an operating voltage range, the voltage stress should be evaluated based on its maximum value.

As shown in FIG. 2, the maximum voltage stress and the inductor current tend to increase as a conversion ratio (CR) increases, while being dependent on the duty ratio D.

### SUMMARY OF THE DISCLOSURE

The present disclosure is directed to providing a hybrid DC-DC boost converter circuit apparatus using an inductor, a capacitor, and transistors.

The present disclosure is also directed to providing a DC-DC boost converter circuit apparatus in which, regardless of changes in operating conditions such as an output voltage and an operating mode, an average current substantially equal to a load current always flows through the inductor.

The present disclosure is also directed to providing a DC-DC boost converter circuit apparatus in which, when an on-resistance of a switch is sufficiently small, an effect of a right-half-plane (RHP) zero that degrades frequency-response performance can be neglected, and in which a dominant pole frequency generated by the inductor and the capacitor is not affected by operating conditions such as a duty ratio.

The present disclosure is also directed to providing a DC-DC boost converter circuit apparatus that enables robust mode transition against noise that may occur in the circuit due to a predetermined guard time applied for each switching decision, thereby preventing an erroneous mode change.

The present disclosure is also directed to providing a DC-DC boost converter circuit apparatus capable of reducing an integrated bootstrap capacitor capacitance for generating a turn-on voltage at a gate of a switch by using a multi-step gate-driving scheme.

According to an aspect of the present disclosure, a DC-DC boost converter circuit apparatus with improved power efficiency and frequency response is provided.

According to an embodiment of the present disclosure, there may be provided a DC-DC boost converter circuit apparatus comprising: an inductor (L); a first flying capacitor (C_{X}) having a first terminal connected to a first terminal of the inductor (L) via a junction node (V_{X1}); a second flying capacitor (C_{Y}) having a first terminal connected to a second terminal of the inductor (L) via a junction node (V_{Y1}); and first to sixth switches (S₁ to S₆) configured to be selectively switched, depending on an operating mode, to deliver current to an output capacitor (C_{OUT}) through either (i) a single path through the inductor (L) or (ii) a dual path through the inductor (L) and the second flying capacitor (C_{Y}).

One terminal of the first switch (S₁) is connected to the first terminal of the inductor (L) via a first junction node (V_{X1}); the second switch (S₂) is disposed in parallel with the first switch (S₁) and is connected to a second terminal of the first flying capacitor (C_{X}) via a second junction node (V_{X2}); the third switch (S₃) is connected in series with the second switch (S₂); one terminal of the fourth switch (S₄) is connected to the second terminal of the inductor (L) via a third junction node (V_{Y1}); the fifth switch (S₅) is disposed in parallel with the first switch (S₁) and is connected to a second terminal of the second flying capacitor (C_{Y}) via a fourth junction node (V_{Y2}); and the sixth switch (S₆) is disposed in parallel with the fourth switch (S₄) and is connected to the second terminal of the second flying capacitor (C_{Y}) via the fourth junction node (V_{Y2}).

The operating mode may be one of a 1D (duty) mode and a 2D mode.

In the 1D mode, during a first phase, the second switch (S₂) is turned ON, the first switch (S₁) and the third switch (S₃) are turned OFF, and the inductor (L) is charged by an input current; during a second phase, the second switch (S₂) is turned OFF, the first switch (S₁) and the third switch (S₃) are turned ON, and the inductor (L) is discharged to deliver current to the output capacitor (C_{OUT}) through the single path; and the fourth switch (S₄) and the fifth switch (S₅) remain always ON and the sixth switch (S₆) remains always OFF.

In the 2D mode, during a first phase, as the second switch (S₂) and the sixth switch (S₆) are turned ON, a first terminal of the second flying capacitor (C_{Y}) is connected to a first terminal of the inductor (L) via the third junction node (V_{Y1}), and a second terminal of the second flying capacitor (C_{Y}) is connected to the sixth switch (S₆) via the fourth junction node (V_{Y2}), thereby charging the second flying capacitor (C_{Y}); and during a second phase, the second switch (S₂) and the sixth switch (S₆) are turned OFF, the first switch (S₁), the third switch (S₃), the fourth switch (S₄), and the fifth switch (S₅) are turned ON, and current is delivered to the output capacitor (C_{OUT}) through a dual path including the inductor (L) and the second flying capacitor (C_{Y}).

The DC-DC boost converter circuit apparatus may further include a mode selector configured to select the operating mode, wherein the mode selector compares a duty ratio (D) of a PWM signal with a reference signal to generate a mode-transition trigger signal (V_{TRG}) to switch the mode, and wherein, upon a first occurrence of the mode-transition trigger signal (V_{TRG}) in each mode, the mode selector activates an internal counter and determines whether to switch the mode based on whether the mode-transition trigger signal (V_{TRG}) occurs after a predetermined time of n cycles.

The DC-DC boost converter circuit apparatus may further include a DC voltage buffer coupled to an output of an error amplifier that receives an output voltage (V_{OUT}) of the output capacitor (C_{OUT}) and a reference voltage (V_{REF}) and outputs an error, wherein the DC voltage buffer generates a DC voltage buffer output (V_{PWM}) having a voltage equal to one of 1 time (1×) and 2 times (2×) an output voltage of the error amplifier depending on the operating mode, and wherein the DC voltage buffer output (V_{PWM}) is used to change the duty ratio (D) according to the operating mode.

The first to sixth switches (S₁ to S₆) may be NMOS transistors, wherein, at the start of the first phase, the first flying capacitor (C_{X}) operates as a bootstrap capacitor for the second switch (S₂), and immediately before the end of the first phase, a gate of the fifth switch (S₅) is temporarily connected to the first junction node (V_{X1}) such that the fifth switch (S₅) is pre-charged by borrowing a voltage of the first flying capacitor (C_{X}); and wherein, at the start of the second phase, an output node (V_{OUT}) operates as a voltage-borrowing source for the first switch (S₁) such that the first switch (S₁) is pre-charged.

At least some of the first to sixth switches (S₁ to S₆) may be pre-charged using, via a residue-charge-sharing scheme, at least one of a capacitor in a charge pump circuit unit and the first flying capacitor (C_{X}).

### BRIEF DESCRIPTION OF DRAWINGS

FIG. 1 is a diagram illustrating a conventional boost converter.

FIG. 2 is a diagram illustrating comparison results between a conventional converter and a converter according to an embodiment of the present disclosure.

FIG. 3 is a diagram illustrating a converter system according to an embodiment of the present disclosure.

FIGS. 4 and 5 are diagrams for explaining switching operations in a 1D mode or a 2D mode according to an embodiment of the present disclosure.

FIG. 6 is a diagram for explaining a malfunction-prevention mechanism of a mode-transition circuit in a converter according to an embodiment of the present disclosure.

FIG. 7 is a diagram for explaining a duty-adjustment principle for noise during a mode transition according to an embodiment of the present disclosure.

FIG. 8 is a diagram for explaining a two-step gate-driving scheme according to an embodiment of the present disclosure.

FIG. 9 is a diagram for explaining a pre-charging technique for two-step gate driving according to an embodiment of the present disclosure.

FIG. 10 is a diagram illustrating per-switch bootstrapping according to an embodiment of the present disclosure.

FIG. 11 is a diagram comparing frequency-response characteristics of a conventional converter and a converter according to an embodiment of the present disclosure.

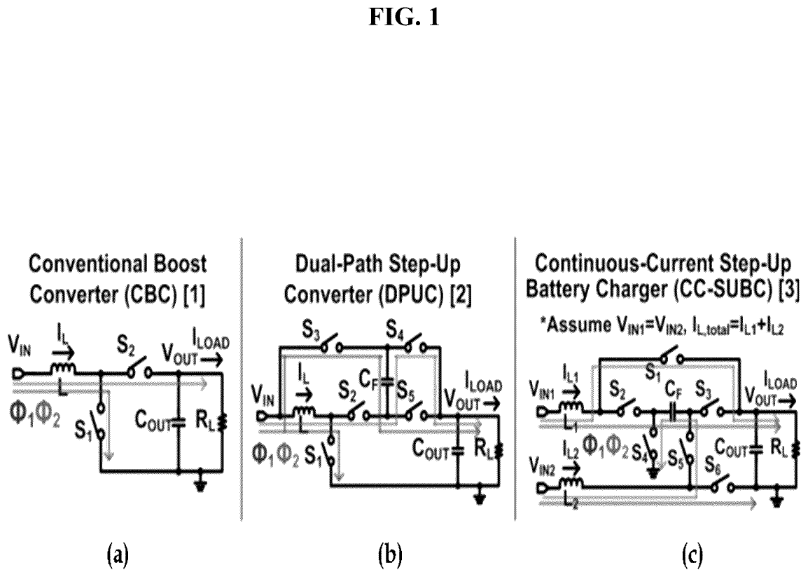

### DETAILED DESCRIPTION

Singular forms used in this specification include plural forms unless the context clearly indicates otherwise. In the specification, the term “configured”, “include”, or the like should not be construed as necessarily including several components or several steps described herein, in which some of the components or steps may not be included or additional components or steps may be further included. Further, the terms “~ unit”, “module”, and the like mean a unit for processing at least one function or operation and may be implemented by hardware or software or by a combination of hardware and software.

Hereinafter, the embodiments of the present disclosure will be described in detail with reference to the accompanying drawings.

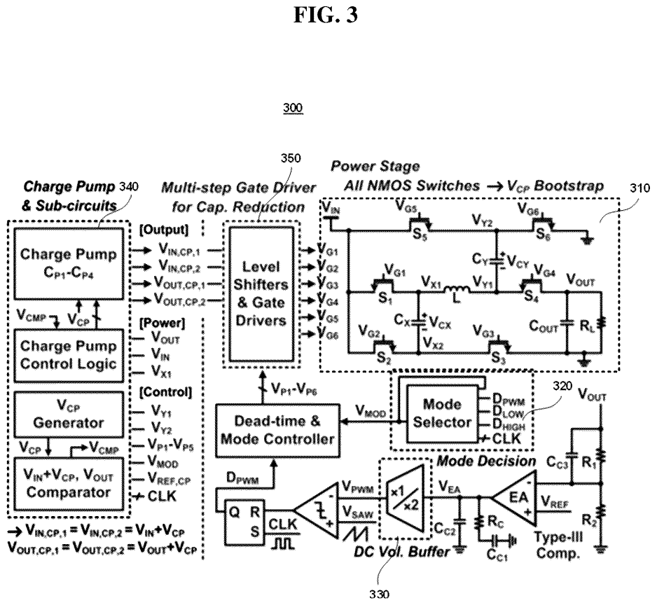

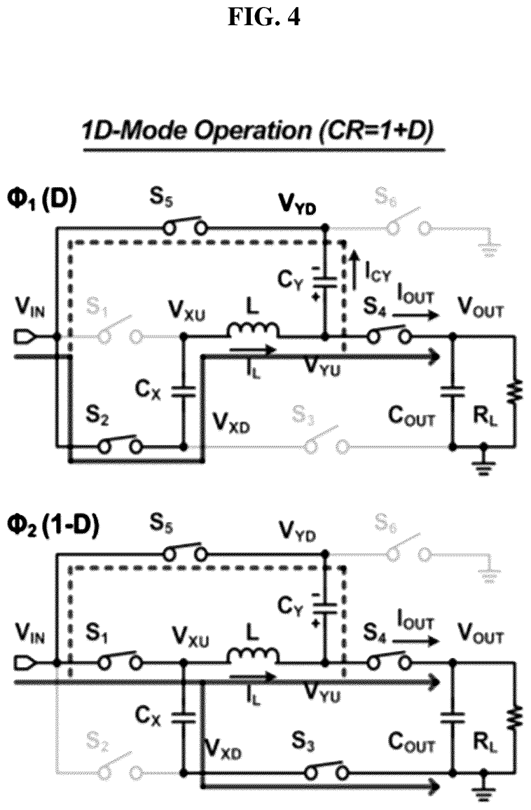

FIG. 3 is a diagram illustrating a system architecture of a converter according to an embodiment of the present disclosure, and FIG. 4 is a diagram for explaining switching operation of the converter according to an embodiment of the present disclosure.

Referring to FIG. 3, a converter system 300 according to an embodiment of the present disclosure includes a DC-DC step-up converter circuit unit 310, a mode selector 320, a DC voltage buffer 330, a charge pump circuit unit 340, a gate driver 350, and a PWM negative-feedback circuit unit. Here, the mode selector 320 may be included in the PWM negative-feedback circuit unit. The PWM negative-feedback circuit unit may further include an error amplifier, a mode controller, and the like; however, these are apparent to those skilled in the art, and thus a detailed description thereof will be omitted, and the following description will focus on components necessary to explain the main aspects of the present disclosure.

The DC-DC step-up converter circuit unit 310 includes one inductor L, one output capacitor C_{OUT}, two flying capacitors C_{X} and C_{Y}, and six switches S₁ to S₆. Hereinafter, the switches S₁ to S₆ may be NMOS switches.

One terminal of the inductor Lis connected to one terminal of a first switch S₁ via a junction node V_{X1}, and is also connected to one terminal of a first flying capacitor C_{X} via the junction node V_{X1}. More specifically, a drain terminal of the first switch S₁ may be connected to one terminal of the inductor L via the junction node V_{X1}. Here, one terminal of the first flying capacitor C_{X} is connected to the inductor L and may convert a voltage by receiving energy generated in the inductor L. That is, when the first switch S₁ is in an ON state, the first flying capacitor C_{X} may receive and store a voltage at the junction node V_{X1} connected to the inductor L. In addition, after storing energy, the first flying capacitor C_{X} may transfer the energy to an output or to another circuit component through interaction with another switch (e.g., S₂). In other words, the first flying capacitor C_{X} can temporarily store energy and, by controlling the stored energy, improve voltage-conversion efficiency.

A second switch S₂ is disposed in parallel with the first switch S₁, and one terminal of the second switch S₂ may be connected to the other terminal of the first flying capacitor C_{X} via a junction node V_{X2}. A source terminal of the first switch S₁ and a source terminal of the second switch S₂ may be connected to each other via a junction node N.

The second switch S₂ may be connected to one terminal of a third switch S₃ via the junction node V_{X2}. That is, a source terminal of the second switch S₂ may be connected to a drain terminal of the third switch S₃ via the junction node V_{X2}.

In addition, the other terminal of the inductor L may be connected to one terminal of a second flying capacitor C_{Y} and to one terminal of a fourth switch S₄ via a junction node V_{Y1}. Here, the other terminal of the inductor L may be connected to a source terminal of the fourth switch S₄ via the junction node V_{Y1}.

Further, the third switch S₃ and the fourth switch S₄ are arranged in parallel, and may be respectively connected to a first terminal of the output capacitor C_{OUT}. Specifically, a source terminal of the third switch S₃ is connected to the first terminal of the output capacitor C_{OUT}, and a drain terminal of the fourth switch S₄ may be connected to a second terminal of the output capacitor C_{OUT}.

One terminal of the second flying capacitor C_{Y} is connected to the other terminal of the inductor L and to the source terminal of the fourth switch S₄ via the junction node V_{Y1}, and the other terminal of the second flying capacitor C_{Y} may be connected to a source terminal of a fifth switch S₅ and to a drain terminal of a sixth switch S₆ via a junction node V_{Y2}.

According to an embodiment of the present disclosure, the DC-DC step-up converter circuit unit 310 may perform switching operation in two modes. The two modes may include a 1D mode and a 2D mode. The DC-DC step-up converter circuit unit 310 may perform the switching operation in either the 1D mode or the 2D mode depending on a conversion ratio.

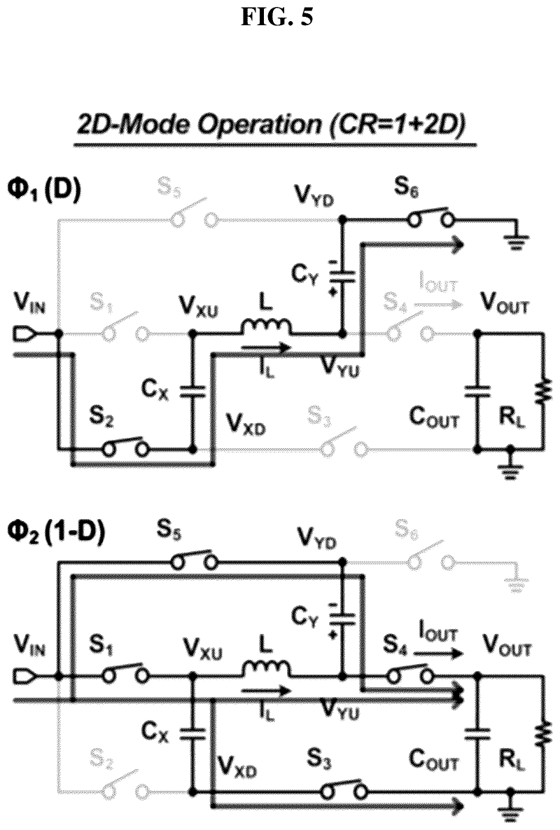

Switching operations of each mode are as shown in FIGS. 4 and 5.

FIG. 4 illustrates switching operation during each phase in a 1D mode. As shown in FIG. 4, in the 1D mode, during a first phase Φ1 maintained for a duty interval D, the second switch S₂ is turned ON, the first switch S₁ and the third switch S₃ are turned OFF, and energy may be charged into the inductor L in the form of current. In the 1D mode, the fourth switch S₄ and the fifth switch S₅ are always turned ON, and the sixth switch S₆ remains always turned OFF.

In a second phase Φ2 of the 1D mode, the second switch S₂ is turned OFF, the first switch S₁ and the third switch S₃ are turned ON, and the energy stored in the inductor L is discharged. Here, the second phase Φ2 may be maintained for a time interval of 1-D. In addition, in the 1D mode, the fourth switch S₄ and the fifth switch S₅ are always turned ON and the sixth switch S₆ remains always turned OFF. Since only three switches (S₁, S₂, and S₃) are switched, switching loss can be minimized.

In summary, in the 1D mode, energy is stored in the inductor L and delivered to the load. Accordingly, the second flying capacitor C_{Y} is always connected between V_{IN} and V_{OUT} during this operation and thus serves as a decoupling capacitor.

FIG. 5 illustrates switching operation in a 2D mode. In the 2D mode, during a first phase, the second switch S₂ and the sixth switch S₆ are turned ON, the first switch S₁, the third switch S₃, the fourth switch S₄, and the fifth switch S₅ are turned OFF, and the inductor L may be charged. Due to additional switching operation of the fourth switch S₄ through the sixth switch S₆, the energy charged into the inductor L per unit time increases, and as a result, a higher output voltage can be generated. A conversion ratio (=output voltage/input voltage) for each mode is given in Equation 1.

$${CR}_{1 D} = \frac{{V}_{OUT}}{{V}_{IN}} = 1 + D , \qquad [ Equation 1 ]$$

$${CR}_{2 D} = \frac{{V}_{OUT}}{{V}_{IN}} = 1 + 2 D$$

$$( 0 < D < 1 )$$

As shown in FIG. 4, in the 1D mode, the right-side node of the inductor L is always connected to the output node, and since there is no other current-delivery path toward the output, the inductor current is maintained at a level equal to the load current.

Referring to FIG. 5, in the 2D mode, current delivery is temporarily interrupted during the first phase Φ1; however, the second flying capacitor C_{Y} additionally delivers current to the output during the second phase Φ2, so that an inductor-capacitor dual path allows the inductor current to be maintained at a level equal to the load current.

In summary, in the 2D mode, during the first phase Φ1 in which the second switch S₂ is turned ON, one terminal of the second flying capacitor C_{Y} is connected to one terminal of the inductor L via the junction node V_{Y1}, and the other terminal of the second flying capacitor C_{Y} is connected to the sixth switch S₆ via the junction node V_{Y2}. As current flows from the one terminal of the second flying capacitor C_{Y}, energy is accumulated in the inductor L, and at the other terminal, a voltage difference is created by the sixth switch S₆ such that the second flying capacitor C_{Y} may be charged. The charging of the second flying capacitor C_{Y} may continue while the second switch S₂ and the sixth switch S₆ remain in the ON state.

In the 2D mode, when the second phase Φ2 starts, switching operation turns OFF the second switch S₂ and the sixth switch S₆ and turns ON the first switch S₁, the third switch S₃, the fourth switch S₄, and the fifth switch S₅, such that current is delivered to the inductor L and the output capacitor C_{OUT} through the second flying capacitor C_{Y}. The second flying capacitor C_{Y} transfers the stored energy to cause current to flow in a path coupled to the inductor L. In this manner, the current of the inductor L can be maintained at a level sufficient to meet the load current. That is, during the second phase, the inductor current can flow through two paths: an inductor path and a path through the second flying capacitor C_{Y}. In other words, the inductor and the capacitor simultaneously supply current. These dual paths cooperate so that the inductor current is not interrupted and the load current demand can be satisfied.

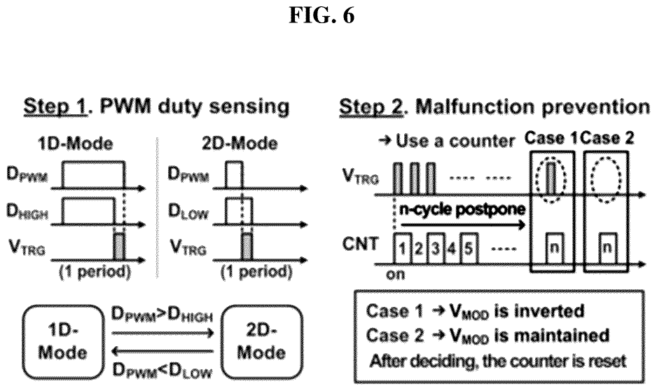

The mode selector 320 may compare, on a per-cycle basis, a duty ratio D of a PWM signal D_{PWM} with reference signals D_{HIGH} and D_{LOW}, and may generate a mode-transition trigger signal V_{TRG} to switch the mode when the duty ratio of the PWM signal is higher than the duty ratio D_{HIGH} in the 1D mode or lower than the duty ratio D_{LOW} in the 2D mode (see FIG. 6). Here, D_{HIGH} and D_{LOW} represent duty ratios of the reference signals.

When the mode-transition trigger signal VIRG is generated, a counter circuit within the mode selector 320 is activated, and the mode selector 320 may determine whether to switch the mode by checking whether the mode-transition trigger signal V_{TRG} continues to occur even after a predetermined number of cycles, thereby preventing an erroneous mode transition caused by temporary noise or a transient condition. If the mode-transition trigger signal VIRG does not occur after an arbitrary time of n cycles elapses after the internal counter circuit is activated, the mode selector 320 may maintain the current mode. In this manner, due to the decision guard time, a more robust mode-transition decision can be made against noise that may temporarily occur in the circuit.

To maintain the same conversion ratio (CR) during a mode transition, the duty ratio D needs to be changed by a factor of two or one-half. However, due to a bandwidth limitation of the feedback control loop, the change of D may not follow the transition speed, thereby causing excessive output-voltage overshoot or undershoot.

To address this issue, in an embodiment of the present disclosure, the DC voltage buffer 330 is used to leverage the fact that the duty ratio D is proportional to an output voltage level V_{EA} of the error amplifier (EA), and that the D ratio between the 1D mode and the 2D mode has an integer-multiple relationship.

The DC voltage buffer 330 is connected to an output of the error amplifier and serves to rapidly change a DC voltage. In a voltage-mode PWM control scheme, a duty ratio is generated by comparing the error-amplifier output V_{EA} with an arbitrary sawtooth waveform V_{SAW}. Even during a mode transition, in order to maintain the same output voltage, it is necessary to instantaneously and rapidly change the duty ratio to a value suitable for each mode. That is, the output of the error amplifier needs to be rapidly adjusted in accordance with the mode-transition speed so that the output voltage is not affected.

However, a conventional negative-feedback-based control circuit has a bandwidth limitation and thus cannot change the duty ratio sufficiently fast. Accordingly, instead of relying on the slowly varying output of the error amplifier, the DC voltage buffer 330 may be coupled to the error-amplifier output to rapidly change the voltage.

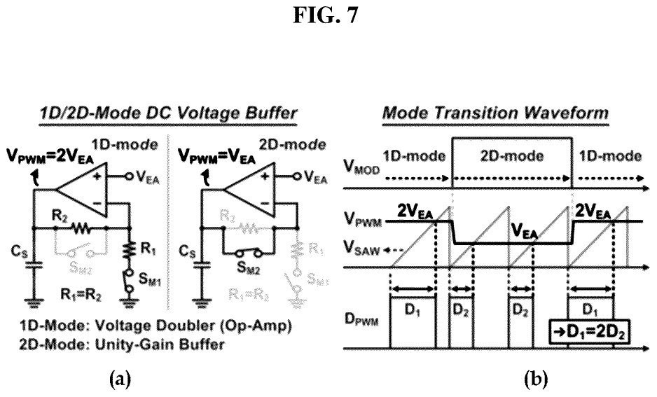

The DC voltage buffer 330 generates a DC voltage buffer output V_{PWM} having a voltage equal to 1 time (1×) or 2 times (2×) the error-amplifier output, depending on an operating mode. That is, as shown in FIG. 7(a), the DC voltage buffer 330 operates as a voltage doubler in the 1D mode and operates as a unity-gain buffer in the 2D mode, thereby generating the DC voltage buffer output V_{PWM} having 1 time (1×) or 2 times (2×) the error-amplifier output voltage. FIG. 7(b) illustrates a principle of rapidly changing the duty ratio according to the mode by using the output of the DC voltage buffer 330.

According to an embodiment of the present disclosure, when a gate voltage required to realize a turn-on state in the switching operation of the DC-DC boost converter circuit unit 310 is higher than an input voltage of the converter, a bootstrap technique is applied to generate a gate voltage higher than a source voltage by using a capacitor.

The charge pump circuit unit 340 includes a plurality of capacitors and serves to boost a gate voltage of a switch. That is, the charge pump circuit unit 340 can provide a sufficient gate-to-source voltage to maintain the switch in an ON state. Accordingly, variation of RON can be reduced and switch performance can be maintained stably. The capacitors of the charge pump circuit unit 340 are charged to a constant voltage V_{CP}, thereby mitigating variation of the switch RON caused by changes in an input voltage V_{IN}.

Gate parasitic capacitors C_{G1} to C_{G6} of the first switch S₁ through the sixth switch S₆ are on the order of several tens of pF, and a gate bootstrap capacitor is about ten times larger than C_{G1} to C_{G6}, thereby potentially occupying a significant silicon area. To address this issue, in an embodiment of the present disclosure, the gate driver 350 applies a two-step gate-voltage rising technique to pre-charge voltages of C_{G1} to C_{G6} before bootstrapping, thereby reducing a capacitance required for bootstrapping.

In a conventional bootstrap scheme, a capacitor is used to raise a switch gate voltage in a single step from a bottom-state voltage V_{BOT} to a turn-on voltage V_{END}. However, a switch used in a power stage has a large parasitic capacitance, and accordingly a bootstrap capacitor having a very large capacitance is required. For example, to drive the switch at 90% of the turn-on voltage, a bootstrap capacitor of approximately nine times the switch capacitance C_{G} is required.

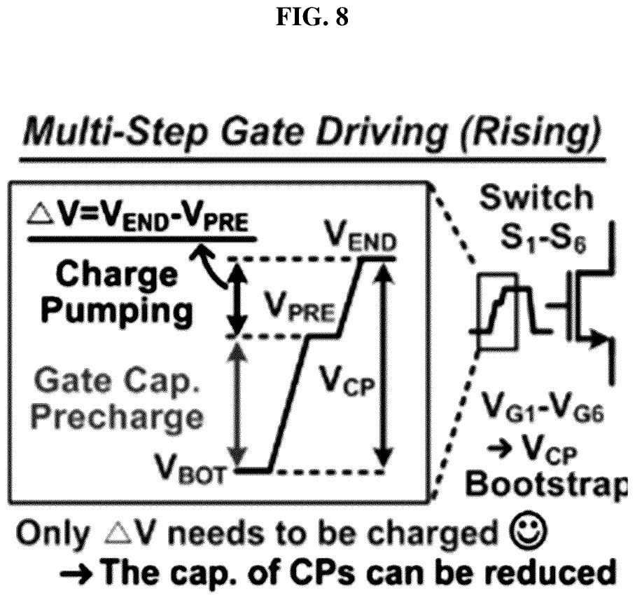

According to an embodiment of the present disclosure, as shown in FIG. 8, a two-step gate-driving scheme may be used to pre-charge a switch gate voltage to a predetermined voltage V_{PRE} before bootstrapping, and then perform bootstrapping. Accordingly, a required capacitance of a bootstrap capacitor can be significantly reduced.

For example, when pre-charging is performed to a level of about 3 V, the required bootstrap capacitance is reduced to about one-third compared with a case in which no pre-charging is performed (V_{PRE}=0 V). The equation used for the calculation is as follows.

$${C}_{BST} = \frac{{V}_{END} - {V}_{PRE}}{{V}_{CP} - ( {V}_{END} - {V}_{BOT} )} {C}_{G} \qquad [ Equation 2 ]$$

Here, C_{BST} denotes a bootstrap capacitor, V_{CP} denotes a bootstrap-capacitor charging voltage, and C_{G} denotes a gate capacitance. The calculation is performed using V_{CP}=5 V and V_{END}=4.5 V.

Two pre-charging methods for the two-step gate driving will be described below.

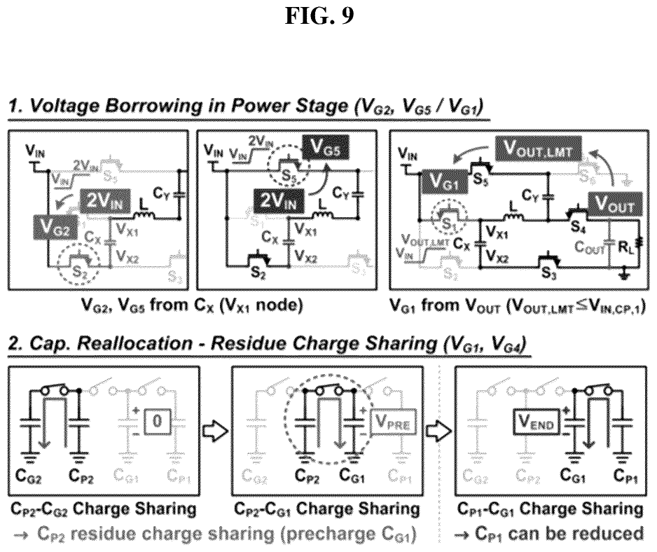

A first method is voltage-borrowing (V_{B}), which is a technique of obtaining a required voltage from a voltage generated at a node within a power stage. For example, as shown in FIG. 9, when each switch is implemented as an NMOS device, the second switch S₂ and the fifth switch S₅ may obtain a voltage for pre-charging from the junction node V_{X1} of the first flying capacitor C_{X}, and the first switch S₁ may obtain a voltage from an output node V_{OUT} during 2D-mode operation.

At the beginning of the first phase Φ1, the first flying capacitor C_{X} is directly used as a bootstrap capacitor for the second switch S₂, and immediately before the end of the first phase Φ1, a gate of the fifth switch S₅ is temporarily connected to the junction node V_{X1} so that a voltage can be borrowed from the first flying capacitor C_{X}. At the beginning of the second phase Φ2, the output voltage V_{OUT} serves as a voltage-borrowing source for the first switch S₁, and a voltage limit V_{OUT,LMT} may be set so as not to exceed a breakdown voltage of the first switch S₁.

A second method is a residue-charge-sharing (RCS) scheme, as shown in FIG. 9, in which residual charge remaining on a capacitor previously used for bootstrapping is transferred to a gate of another switch to pre-charge the gate.

For example, as shown in FIG. 9, a capacitor C_{P2} in the charge pump circuit unit bootstraps a gate capacitance C_{G2} of the second switch S₂, and then, by sharing the remaining charge to pre-charge a gate capacitance C_{G1} of the first switch S₁ before C_{P2} is recharged, a bootstrap capacitance subsequently required for C_{G1} can be effectively reduced. In this case, a required gate-voltage increase is reduced from V_{END}-V_{BOT} to V_{END}-V_{PRE}, thereby reducing a required capacitance of a capacitor C_{P1} for bootstrapping the first switch S₁.

In the 1D mode, a gate voltage V_{G1} of the first switch S₁ may be pre-charged by residue-charge-sharing from a capacitor C_{P2} or a capacitor C_{P3} in the charge pump circuit unit, and then bootstrapped by a capacitor C_{P1}. A gate voltage V_{G2} of the second switch S₂ may be pre-charged by voltage borrowing from the first flying capacitor C_{X}, and then alternately bootstrapped by the capacitor C_{P2} or the capacitor C_{P3}.

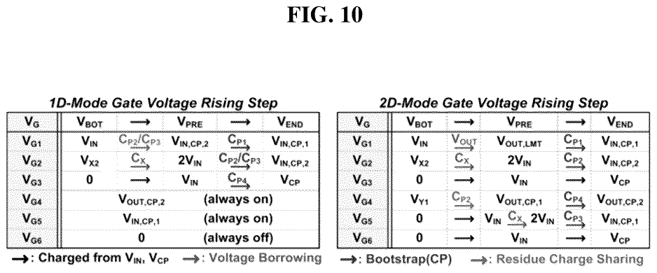

Similarly, in the 2D mode, a gate voltage V_{G1} of the first switch S₁, a gate voltage V_{G2} of the second switch S₂, and a gate voltage V_{G5} of the fifth switch S₅ may be respectively pre-charged by voltage borrowing from an output node V_{OUT} or the first flying capacitor C_{X}, and then alternately bootstrapped by capacitors C_{P1}, C_{P2}, and C_{P3} in the charge pump circuit unit. FIG. 10 illustrates gate-voltage rising steps in each mode.

When all switches are NMOS devices, the charge pump circuit unit 340 may use a total of four capacitors C_{P1} to C_{P4}. In other words, in the 1D mode, the first switch S₁ is alternately pre-charged, on a per-cycle basis, by a residue-charge-sharing scheme from C_{P2} or C_{P3} to secure a charging time for the capacitors, and the second switch S₂ is pre-charged by a voltage-borrowing scheme from the junction node V_{X1}.

Further, in the 2D mode, the first switch S₁, the second switch S₂, and the fifth switch S₅ may be pre-charged by a voltage-borrowing scheme from the junction node V_{X1} or an output-voltage node, and the fourth switch S₄ may be pre-charged by a residue-charge-sharing scheme from C_{P2}. After the pre-charging step, the charge-pump capacitors C_{P1} to C_{P4} may be used for bootstrapping the respective switches.

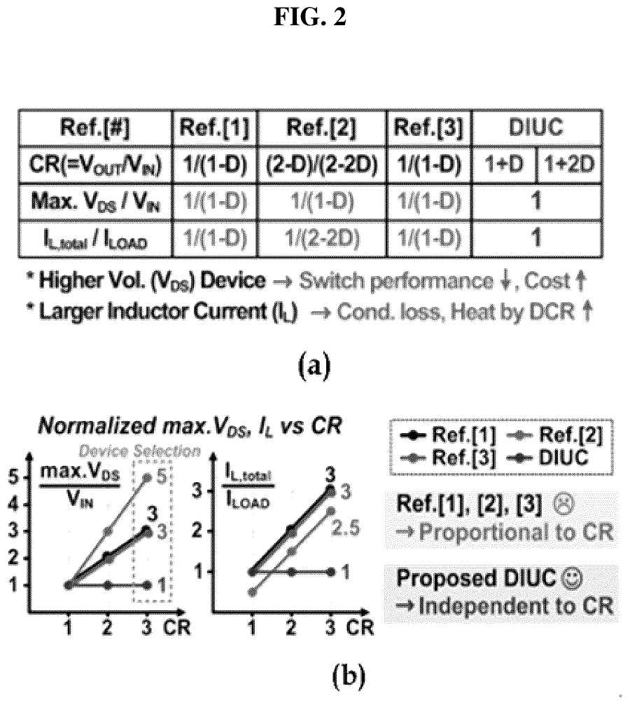

As shown in FIG. 2, the DC-DC boost converter circuit unit 310 according to an embodiment of the present disclosure has characteristics in which voltage stress and inductor current are independent of a duty ratio and a conversion ratio. In addition, since low voltage stress at an input-voltage level is applied to all switch devices, low-voltage transistors can be used, thereby reducing switching loss. Further, because the inductor current is always equal to the load current over an entire operating range, conduction loss generated in the inductor is relatively small, and thus efficiency can be improved while also improving frequency response.

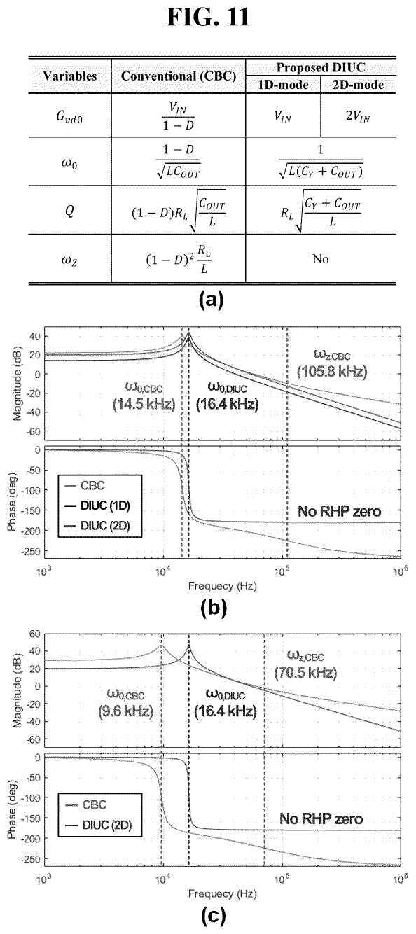

In FIG. 11(a), assuming that an on-resistance (RON) of the switches is sufficiently small to be neglected, key variables in the power-stage transfer functions of the conventional converter of FIG. 2 and the converter circuit apparatus according to an embodiment of the present disclosure are compared. In the conventional converter, the variables include terms associated with the duty factor (1−D) and a load resistance RL. Thus, when these values change, the system transfer function changes. As a result, when the output voltage increases or the load current increases, the dominant pole frequency and the right-half-plane (RHP) zero frequency may move closer to each other, thereby implying a possibility that the system may become unstable.

In contrast, in the proposed converter, the dominant pole frequency is independent of the duty ratio and the load current, and no right-half-plane (RHP) zero frequency is present. Accordingly, the proposed converter has characteristics that are more advantageous for ensuring system stability.

A Bode plot visually shows the frequency-response characteristics of the system compared in FIG. 11(a). Bode plots for an output voltage of 8 V (FIG. 11(b)) and an output voltage of 12 V (FIG. 11(c)) are compared while maintaining other conditions the same. In the conventional boost converter, the dominant pole frequency and the RHP zero frequency change as the output voltage changes. However, in the converter circuit apparatus according to an embodiment of the present disclosure, the dominant pole frequency remains constant, and the phase of the power stage does not decrease to −180° or lower.

The hardware device may be configured to operate as one or more software modules to perform the operation of the present disclosure, and vice versa.

The present disclosure was described above focusing on the embodiments thereof. It would be understood by those skilled in the art that the present disclosure may be implemented in a modified form without departing from the scope of the present disclosure. Therefore, the disclosed embodiments should be considered in terms of explaining, not limiting. The scope of the present disclosure is shown in the claims, not in the above description, and all differences within an equivalent range should be construed as being included in the present disclosure.

What is claimed is:

1. A DC-DC boost converter circuit apparatus comprising:
an inductor (L);
a first flying capacitor (C_{X}) having a first terminal connected to a first terminal of the inductor (L) via a junction node (V_{X1});
a second flying capacitor (C_{Y}) having a first terminal connected to a second terminal of the inductor (L) via a junction node (V_{Y1}); and
first to sixth switches (S₁ to S₆) configured to be selectively switched, depending on an operating mode, to deliver current to an output capacitor (C_{OUT}) through either (i) a single path through the inductor (L) or (ii) a dual path through the inductor (L) and the second flying capacitor (C_{Y}).

2. The DC-DC boost converter circuit apparatus of claim 1, wherein:
one terminal of the first switch (S₁) is connected to the first terminal of the inductor (L) via a first junction node (V_{X1});
the second switch (S₂) is disposed in parallel with the first switch (S₁) and is connected to a second terminal of the first flying capacitor (C_{X}) via a second junction node (V_{X2});
the third switch (S₃) is connected in series with the second switch (S₂);
one terminal of the fourth switch (S₄) is connected to the second terminal of the inductor (L) via a third junction node (V_{Y1});
the fifth switch (S₅) is disposed in parallel with the first switch (S₁) and is connected to a second terminal of the second flying capacitor (C_{Y}) via a fourth junction node (V_{Y2}); and
the sixth switch (S₆) is disposed in parallel with the fourth switch (S₄) and is connected to the second terminal of the second flying capacitor (C_{Y}) via the fourth junction node (V_{Y2}).

3. The DC-DC boost converter circuit apparatus of claim 2,
wherein the operating mode is one of a 1D (duty) mode and a 2D mode.

4. The DC-DC boost converter circuit apparatus of claim 3,
wherein, in the 1D mode:
during a first phase, the second switch (S₂) is turned ON, the first switch (S₁) and the third switch (S₃) are turned OFF, and the inductor (L) is charged by an input current;
during a second phase, the second switch (S₂) is turned OFF, the first switch (S₁) and the third switch (S₃) are turned ON, and the inductor (L) is discharged to deliver current to the output capacitor (C_{OUT}) through the single path; and
the fourth switch (S₄) and the fifth switch (S₅) remain always ON and the sixth switch (S₆) remains always OFF.

5. The DC-DC boost converter circuit apparatus of claim 3,
wherein, in the 2D mode:
during a first phase, as the second switch (S₂) and the sixth switch (S₆) are turned ON, a first terminal of the second flying capacitor (C_{Y}) is connected to a first terminal of the inductor (L) via the third junction node (V_{Y1}), and a second terminal of the second flying capacitor (C_{Y}) is connected to the sixth switch (S₆) via the fourth junction node (V_{Y2}), thereby charging the second flying capacitor (C_{Y}); and
during a second phase, the second switch (S₂) and the sixth switch (S₆) are turned OFF, the first switch (S₁), the third switch (S₃), the fourth switch (S₄), and the fifth switch (S₅) are turned ON, and current is delivered to the output capacitor (C_{OUT}) through a dual path including the inductor (L) and the second flying capacitor (C_{Y}).

6. The DC-DC boost converter circuit apparatus of claim 3,
further comprising a mode selector configured to select the operating mode,
wherein the mode selector compares a duty ratio (D) of a PWM signal with a reference signal to generate a mode-transition trigger signal (V_{TRG}) to switch the mode, and
wherein, upon a first occurrence of the mode-transition trigger signal (V_{TRG}) in each mode, the mode selector activates an internal counter and determines whether to switch the mode based on whether the mode-transition trigger signal (V_{TRG}) occurs after a predetermined time of n cycles.

7. The DC-DC boost converter circuit apparatus of claim 3,
further comprising a DC voltage buffer coupled to an output of an error amplifier that receives an output voltage (V_{OUT}) of the output capacitor (C_{OUT}) and a reference voltage (V_{REF}) and outputs an error,
wherein the DC voltage buffer generates a DC voltage buffer output (V_{PWM}) having a voltage equal to one of 1 time (1×) and 2 times (2×) an output voltage of the error amplifier depending on the operating mode, and
wherein the DC voltage buffer output (V_{PWM}) is used to change the duty ratio (D) according to the operating mode.

8. The DC-DC boost converter circuit apparatus of claim 3,
wherein the first to sixth switches (S₁ to S₆) are NMOS transistors,
wherein, at the start of the first phase, the first flying capacitor (C_{X}) operates as a bootstrap capacitor for the second switch (S₂), and immediately before the end of the first phase, a gate of the fifth switch (S₅) is temporarily connected to the first junction node (V_{X1}) such that the fifth switch (S₅) is pre-charged by borrowing a voltage of the first flying capacitor (C_{X}); and
wherein, at the start of the second phase, an output node (V_{OUT}) operates as a voltage-borrowing source for the first switch (S₁) such that the first switch (S₁) is pre-charged.

9. The DC-DC boost converter circuit apparatus of claim 3,
wherein at least some of the first to sixth switches (S₁ to S₆) are pre-charged using, via a residue-charge-sharing scheme, at least one of a capacitor in a charge pump circuit unit and the first flying capacitor (C_{X}).
